(19) United States
(12) Patent Application Publication
(10) Pub. No.: US 2020/0097034 A1
(43) Pub. Date: Mar. 26, 2020

(54) VOLTAGE REGULATOR

(71) Applicant: Nordic Semiconductor ASA, Trondheim (NO)

(72) Inventors: Joar Olai RUSTEN, Trondheim (NO); Bartosz GAJDA, Trondheim (NO)

(73) Assignee: Nordic Semiconductor ASA, Trondheim (NO)

(21) Appl. No.: 16/472,123

(22) PCT Filed: Dec. 20, 2017
(86) PCT No.: PCT/GB2017/053838

§ 371 Date: Jun. 20, 2019

(30) Foreign Application Priority Data
Dec. 21, 2016 (GB) 1621900.8

(51) Int. Cl. G05F 1/575; H02M 3/156

(52) U.S. Cl. CPC G05F 1/575; H02M 2001/0003; H02M 3/156

(57) ABSTRACT

An electronic device comprises at least one voltage regulating circuit portion connected to a first node and a current source connected to a second node. A detection circuit portion is arranged to determine whether an inductor is connected between the first and second nodes and to produce a ready signal indicative thereof. The voltage regulating circuit portion requires the inductor to be connected between the first and second nodes in order to operate.

The present invention relates to power management systems, particularly but not exclusively, power management systems implemented on integrated circuits for controlling electronic devices having more than one voltage regulator.

Modern portable electronic devices are typically provided with a power source such as a battery that acts as a direct current (DC) power supply for the various electronic components within the device. However, typically these components will have different voltage requirements and so it is conventional for such devices to employ one or more voltage regulators that step a nominal voltage associated with the power supply down to a voltage appropriate for the different electronic components.

Some such electronic devices include more than one voltage regulator for distributing power at different voltage levels to various circuits, subsystems, and components within the device. These different voltage regulators may, by way of example only, provide different voltage ranges and efficiencies. Presently it may be necessary for a user implementing an integrated circuit which supports multiple voltage regulators to make a manual selection as to which will be used.

When viewed from a first aspect, the present invention provides an electronic device comprising:
at least one voltage regulating circuit portion connected to a first node;
a current source connected to a second node; and
a detection circuit portion arranged to determine whether an inductor is connected between the first and second nodes and to produce a ready signal indicative thereof;
wherein the voltage regulating circuit portion requires the inductor to be connected between the first and second nodes in order to operate.

Thus it will be appreciated by those skilled in the art that the present invention provides an electronic device that can determine whether or not an inductor is connected to the device and therefore whether the voltage regulator which requires it is available for use. This may be particularly beneficial where an electronic device comprises a voltage regulator implemented using a DC-DC converter such as a buck converter that requires the presence of an inductor within the circuit to function. The invention may overcome the problem whereby a user is presented with a selection of the voltage regulators available for use but without there being a determination as to whether the requisite inductor is connected. This may, in accordance with some embodiments, provide a mechanism for automatically enabling a voltage regulator that requires the inductor. Additionally or alternatively, embodiments of the present invention may provide a mechanism to warn a user that they are trying to enable a voltage regulator that requires but has not been provided with an inductor and prevent the voltage regulator from being enabled.

In a set of embodiments the ready signal is used to inform a user as to the availability of the voltage regulator. This may be achieved by using the ready signal to produce a visual or audible alert, or in at least in some embodiments, the ready signal may comprise a flag that is written to a register. This register may be accessed by software and, if the flag is set, automatically notify the user that the inductor is connected, or in some embodiments is not connected (e.g. by producing an error), between the first and second nodes.

It will of course be appreciated that the step of producing the ready signal may be carried out via any suitable means, however in preferred arrangements the ready signal is a digital signal, such that if the inductor is detected, the ready signal is set to a first value (e.g. logic high) but if the inductor is not detected, the ready signal is set to a second value (e.g. logic low). Thus in some embodiments, producing the ready signal comprises setting the ready signal to a first value if the detection circuit portion determines that the inductor is connected between the first and second nodes, and setting the ready signal to a second value otherwise.

In a set of embodiments, the detection circuit portion comprises a comparator and is arranged to detect whether a voltage at the first node reaches a predetermined threshold within a predetermined period of time and to generate the ready signal if so. In such embodiments, if an inductor is connected between the first and second nodes, the constant current provided by the current source will cause a linear increase in the voltage at the first node. If this linear increase causes the voltage at the first node to reach the predetermined threshold in sufficient time, the detection circuit portion may assume that there is an inductor connected and that the voltage regulating circuit portion may be used.

In a set of embodiments the detection circuit portion is arranged to write a value to a non-volatile memory in the event that it determines that an inductor is present and/or in the event that it determines that an inductor is not present. The stored value could, for example, be used by a debugger when programming the device to indicate that the firmware contains an error because it is trying to enable a regulator which requires an inductor even though no inductor is present.

As mentioned above, in conventional user configurable system-on-chip (SoC) solutions, a user may decide whether or not to enable a particular voltage regulator within the device that requires the presence of an inductor. However, the Applicant has appreciated that typical SoC devices have no mechanism to check that the inductor is actually present and so the user may inadvertently enable a regulator that cannot function. However, by detecting whether or not an inductor is connected to the device in accordance with embodiments of the present invention, the determination of whether a particular voltage regulator can be enabled can be made automatically. This information may be relayed to the user before attempting to enable the voltage regulator or, more preferably, prevent the voltage regulator from being enabled at all.

In a set of embodiments, the electronic device further comprises a second voltage regulating circuit portion and a power management system arranged automatically to enable the first voltage regulating circuit portion only if the ready signal is indicative of the inductor being connected between the first and second nodes. Thus in accordance with such embodiments, electronic device that can selectively enable a particular voltage regulator thereof depending on whether or not an inductor is connected to the device.

This is novel and inventive in its own right and thus when viewed from a second aspect, the present invention provides an electronic device comprising:
at least first and second voltage regulating circuit portions connected to a first node;
a current source connected to a second node;
a detection circuit portion arranged to determine whether an inductor is connected between the first and second nodes and to produce a ready signal indicative thereof; and
a power management system arranged automatically to enable the first voltage regulating circuit portion only if said ready signal is indicative of the inductor being connected between the first and second nodes;
wherein the voltage regulating circuit portion requires the inductor to be connected between the first and second nodes in order to operate.

As the enablement of the first voltage regulating circuit portion depends on the presence of the inductor, the first voltage regulating circuit portion may be disabled in the absence of said inductor. Accordingly, in some embodiments the power management system is arranged to disable the first voltage regulating circuit portion if the ready signal is not indicative of the inductor being connected between the first and second nodes.

The power management system is preferably arranged to disable the second voltage regulating circuit portion if the ready signal is indicative of the inductor being connected between the first and second nodes. Similarly, in some embodiments the power management system is arranged to enable the second voltage regulating circuit portion if the ready signal is not indicative of the inductor being connected between the first and second nodes.

While there are numerous topologies for implementing voltage regulating circuit portions that are known in the art per se, in at least some preferred embodiments the first voltage regulating circuit portion comprises a buck converter circuit portion. A buck converter circuit utilises an inductor-capacitor or “LC” circuit which is periodically connected to and disconnected from the power supply (e.g. by intermittently opening and closing a switch, typically implemented as a transistor referred to as the “high-side” transistor) by a driver in order to step down the voltage. This can be seen as an electrical equivalent to a mechanical flywheel, wherein energy is periodically input to the system to keep it outputting energy at a steady rate. The ratio of the output voltage to the input voltage can be adjusted by altering the duty cycle of a pulse width modulated (PWM) drive signal produced by the driver that is applied to the gate of the high-side transistor in order to open and close it.

By way of contrast, the second voltage regulating circuit portion may require no such inductor in order to operate. A number of topologies for voltage regulators that do not rely on an inductor are also known in the art per se. In some embodiments the second voltage regulating circuit portion comprises a low-dropout voltage regulator circuit portion. Low-dropout (LDO) voltage regulators are linear DC voltage regulators that are capable of operating with very low input-output differential voltages. The advantages of such regulators with respect to other types of voltage regulators include having a lower minimum operating voltage.

In some embodiments, the first node is connected to ground via a capacitor. This capacitor may, at least in a set of embodiments, form part of the first voltage regulating circuit portion (e.g. part of a buck converter). However, this capacitor may additionally or alternatively provide a connection to ground for any further voltage regulating circuit portions (e.g. where appropriate, the second voltage regulating circuit portion).

In some embodiments, the first node is pulled to ground when the device is initialised. This prevents the comparator (where provided) from being triggered erroneously if the first node is floating (i.e. its voltage is not well defined) when the device is initially powered up.

Certain embodiments of the present invention will now be described with reference to the accompanying drawings in which:

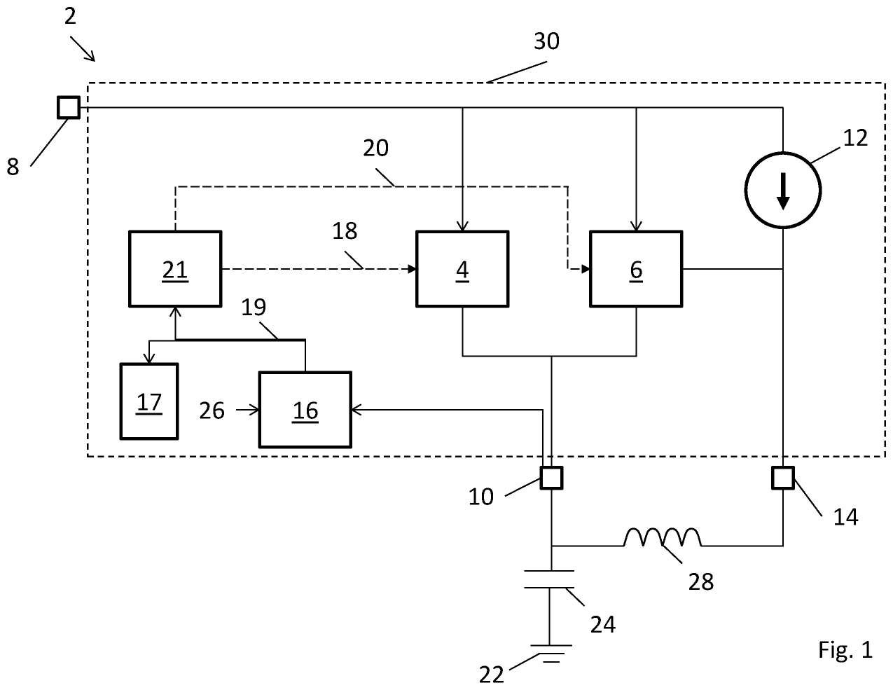

FIG. 1 shows a voltage regulating device in accordance with an embodiment of the present invention when an inductor is connected; and

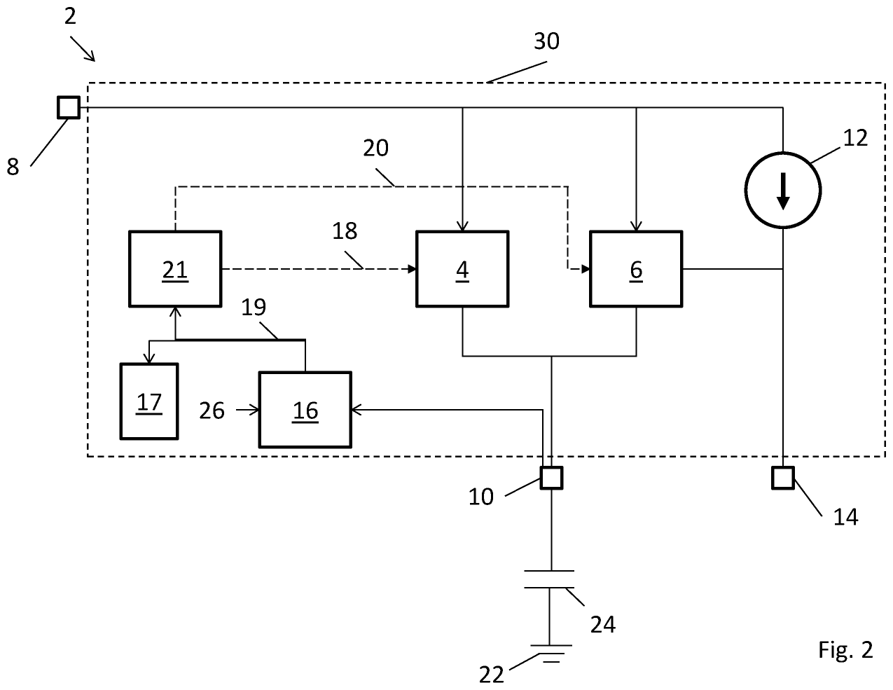

FIG. 2 shows the voltage regulating device of FIG. 1 when an inductor is not connected.

FIG. 1 shows a voltage regulating device 2 in accordance with an embodiment of the present invention. The voltage regulating device 2 comprises a low-dropout regulator (LDO) 4 and a buck converter 6 and are provided on-chip as illustrated by the dashed line 30. The LDO 4 and the buck converter 6 are connected to a supply voltage 8 and to a first node 10 which is connected to ground 22 via a capacitor 24 which forms part of both the buck converter 6 and the LDO 4. The voltage regulating device 2 further comprises a current source 12 which is connected to the voltage supply 8 and to a second node 14. A comparator 16 is connected to the first node 10 and is arranged to compare the voltage at the first node 10 to a reference voltage 26.

The comparator 16 is further arranged to produce a ready signal 19 that is indicative of whether or not the voltage at the first node 10 exceeds the reference voltage 26 within a predetermined amount of time. If the inductor 28 is present, the voltage across the capacitor 24 (and thus the voltage at the first node 10 monitored by the comparator 16) will increase linearly in response to the constant current provided by the current source 12. The comparator 16 may be arranged to measure the time itself, e.g. using an internal clock, or may be provided with timing signals (such as start and stop signals) from an external clock unit (not shown). Alternatively, the comparator 16 may be instructed to take a sample of the voltage at the first node 10 a set amount of time after start-up. This ready signal 19 is then stored in memory 17, e.g. in a register, which may be accessed by software or further hardware (not shown) in order to indicate to a user whether or not an inductor 28 has been detected between the first and second nodes 10, 14.

The ready signal 19 produced by the comparator 16 is input to an optional power management unit 21 that is arranged selectively to enable the LDO 4 and the buck converter 6 via control lines 18 and 20 respectively depending on the whether the ready signal 19 is set or not.

At start-up, before enabling either the LDO 4 or the buck converter 6, the first node 10 is weakly pulled to ground 22 to prevent it from floating, e.g. using a fixed resistor with a large resistance value (not shown) that is disconnected after start-up of the device 2. The current source 12 feeds a current into the second node 14 causing the voltage at the first node 10 to rise. If an inductor 28 is connected between the first node 10 and the second node 14, the voltage at the first node 10 will reach the reference voltage 26 within a predetermined period of time. If this occurs, the comparator 16 will set the value of the ready signal 19 to logic high, which is subsequently stored in the memory 17 and the user may be informed (e.g. using a visual alert) that the buck converter 6 may be enabled as the inductor 28 is connected between the first and second nodes 10, 14.

If the comparator 16 determines that the inductor 28 is present and the optional power management unit 21 is being used, the buck converter 6 is automatically enabled via control line 20 while the LDO 4 is disabled via the control line 18. By way of contrast, FIG. 2 shows the situation in which the comparator 16 determines that the inductor 28 is not present and so sets the value of the ready signal 19 to logic low. In this case, the buck converter 6 is disabled by the power management unit 21 via control line 20 while the LDO 4 is enabled via the control line 18.

Thus it will be seen that an electronic device that can indicate to a user whether or not an inductor is connected and thus whether a voltage regulator that requires such an inductor may be used and optionally automatically enable the voltage regulator has been described herein. Although a particular embodiment has been described in detail, it will be appreciated by those skilled in the art that many variations and modifications are possible using the principles of the invention set out herein.

1. An electronic device comprising:
at least one voltage regulating circuit portion connected to a first node;
a current source connected to a second node; and
a detection circuit portion arranged to determine whether an inductor is connected between the first and second nodes and to produce a ready signal indicative thereof;
wherein the voltage regulating circuit portion requires the inductor to be connected between the first and second nodes in order to operate.

2. The electronic device of claim 1 comprising a voltage regulator implemented using a DC-DC converter that requires the presence of an inductor within the circuit to function.

3. The electronic device of claim 1 arranged automatically to enable a voltage regulator that requires the inductor.

4. The electronic device of claim 1 comprising a mechanism to warn a user that they are trying to enable a voltage regulator that requires but has not been provided with an inductor and prevent the voltage regulator from being enabled.

5. The electronic device of claim 1 wherein the ready signal is used to inform a user as to the availability of the voltage regulator.

6. The electronic device of claim 1 wherein the ready signal is arranged to produce a visual or audible alert

7. The electronic device of claim 1 wherein the ready signal comprises a flag that is written to a register.

8. The electronic device of claim 1 wherein the ready signal is a digital signal, such that if the inductor is detected, the ready signal is set to a first value but if the inductor is not detected, the ready signal is set to a second value

9. The electronic device of claim 1 arranged to set the ready signal to a first value if the detection circuit portion determines that the inductor is connected between the first and second nodes and to set the ready signal to a second value otherwise.

10. The electronic device of claim 1 wherein the detection circuit portion comprises a comparator and is arranged to detect whether a voltage at the first node reaches a predetermined threshold within a predetermined period of time and to generate the ready signal if so.

11. The electronic device of claim 1 wherein the detection circuit portion is arranged to write a value to a non-volatile memory in the event that it determines that an inductor is present and/or in the event that it determines that an inductor is not present.

12. The electronic device of claim 1 wherein the electronic device further comprises a second voltage regulating circuit portion and a power management system arranged automatically to enable the first voltage regulating circuit portion only if the ready signal is indicative of the inductor being connected between the first and second nodes.

13. An electronic device comprising:
at least first and second voltage regulating circuit portions connected to a first node;
a current source connected to a second node;
a detection circuit portion arranged to determine whether an inductor is connected between the first and second nodes and to produce a ready signal indicative thereof; and
a power management system arranged automatically to enable the first voltage regulating circuit portion only if said ready signal is indicative of the inductor being connected between the first and second nodes;
wherein the voltage regulating circuit portion requires the inductor to be connected between the first and second nodes in order to operate.

14. The electronic device of claim 13 wherein the power management system is arranged to disable the first voltage regulating circuit portion if the ready signal is not indicative of the inductor being connected between the first and second nodes.

15. The electronic device of claim 13 wherein the power management system is arranged to disable the second voltage regulating circuit portion if the ready signal is indicative of the inductor being connected between the first and second nodes.

16. The electronic device of claim 13 wherein the power management system is arranged to enable the second voltage regulating circuit portion if the ready signal is not indicative of the inductor being connected between the first and second nodes.

17. The electronic device of claim 13 wherein the first voltage regulating circuit portion comprises a buck converter circuit portion.

18. The electronic device of claim 13 wherein the second voltage regulating circuit portion comprises a low-dropout voltage regulator circuit portion.

19. The electronic device of claim 13 wherein the first node is connected to ground via a capacitor.

20. The electronic device of claim 19 wherein said capacitor forms part of the first voltage regulating circuit portion.

21. The electronic device of claim 13 wherein the first node is pulled to ground when the device is initialised.
